(19) United States
(12) Patent Application Publication
(10) Pub. No.: US 2007/0229284 A1
(43) Pub. Date: Oct. 4, 2007

(54) Radio frequency identification tag and method of forming the same

(76) Inventors: Richard Keith Svalesen, Mesquite, TX (US); Dean L. Frew, McKinney, TX (US)

Correspondence Address: SLATER & MATSIL, L.L.P., 17950 PRESTON RD, SUITE 1000, DALLAS, TX, 75252-5793, US

(21) Appl. No.: 11/724,587

(22) Filed: Mar. 15, 2007

Related U.S. Application Data
(60) Provisional application No. 60/783,782, filed on Mar. 17, 2006.

(51) Int. Cl. G08B 13/14

(52) U.S. Cl. 340/572.8

(57) ABSTRACT

A radio frequency identification (RFID) tag and method of forming the same are presented. In one embodiment, the RFID tag includes an integrated circuit located in a carrier and an adhesive coupled to the carrier. The RFID tag also includes a strain relief member coupled to the adhesive on a surface opposite the carrier and an encapsulant surrounding the carrier, the adhesive and the strain relief member.

This application claims the benefit of U.S. Provisional Application No. 60/783,782, entitled “Rugged RFID Tag,” filed on Mar. 17, 2006, which application is incorporated herein by reference.

### TECHNICAL FIELD

The present invention is directed, in general, to radio frequency identification (“RFID”) systems and, in particular, to an RFID tag and a method of forming the same.

### BACKGROUND

While the core technologies that support radio frequency identification (“RFID”) systems have been around for some time, the applications that drive the use thereof have been slow to market. The aforementioned trend has been turning in an impressive fashion as the size and cost of the RFID tags has decreased and the sensitivity of the RFID readers has increased. Moreover, the market forces, especially with respect to the supply chain in the retail industry, are pulling the RFID technologies into the mainstream and literally onto the shelves.

Oftentimes in RFID applications, a situation arises wherein a standard RFID tag will not survive the harsh realities of the environment. There are also times when the RFID tag will not perform due to the physics of the radio waves associated therewith. There are also issues in using an exposed RFID tag in food grade applications, as the RFID tag may not meet the sanitary requirements. An RFID tag subject to less than ideal environment conditions may fail due to extreme mechanical stresses. For instance, the failure may be a result of repeated crumpling or folding and impacting or ramming (like on transport carts that bump into one another) of the RFID tag.

Additionally, an RFID tag may be encapsulated to protect the RFID tag from environmental conditions such as extreme temperatures, humidity, frost/ice, and corrosive/caustic conditions. Oftentimes, multiple factors are present. The RFID tag may also be encapsulated to keep the RFID tag performing in difficult or “RFID unfriendly” conditions such as an RFID tag located on a metal object. The nature of the RFID tag causes concerns when applied to metal, and proper encapsulation may allow the RFID tag to perform as expected on metals and similarly situated difficult materials. The RFID tag may also be encapsulated if used in sanitary or “clean room” applications as the exposed RFID tag may pose a health risk.

In these extreme instances, the RFID tag encapsulation is useful to leverage the radio frequency capability thereof, while protecting the RFID tag, thereby ensuring its performance as well as its use in otherwise inapplicable environments (for example, food processing containers). Accordingly, what is needed in the art is an RFID tag and a method of forming the same that can accommodate the applications in less than ideal environments that lie ahead.

### SUMMARY OF THE INVENTION

These and other problems are generally solved or circumvented, and technical advantages are generally achieved, by advantageous embodiments of the present invention that include a radio frequency identification (“RFID”) tag and method of forming the same. In one embodiment, the RFID tag includes an integrated circuit located in a carrier and an adhesive coupled to the carrier. The RFID tag also includes a strain relief member coupled to the adhesive on a surface opposite the carrier and an encapsulant surrounding the carrier, the adhesive and the strain relief member.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures or processes for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 illustrates a system level diagram of an embodiment of an RFID system constructed according to the principles of the present invention;

FIG. 2 illustrates a block diagram of an embodiment of an RFID tag constructed according to the principles of the present invention;

FIG. 3 illustrates a block diagram of an embodiment of an RFID tag constructed according to the principles of the present invention; and

FIG. 4 illustrates a perspective view of an embodiment of an RFID tag constructed according to the principles of the present invention.

### DETAILED DESCRIPTION OF ILLUSTRATIVE EMBODIMENTS

The making and using of the presently preferred embodiments are discussed in detail below. It should be appreciated, however, that the present invention provides many applicable inventive concepts that can be embodied in a wide variety of specific contexts. The specific embodiments discussed are merely illustrative of specific ways to make and use the invention, and do not limit the scope of the invention. Unless otherwise provided, like designators for devices employed in different embodiments illustrated and described herein do not necessarily mean that the similarly designated devices are constructed in the same manner or operate in the same way. The present invention will be described with respect to an exemplary embodiment in a specific context, namely, an RFID system including an RFID tag. The RFID tag is employable in any application and is particularly useful when applied to objects subject to less than ideal environmental conditions such as in the food processing industry.

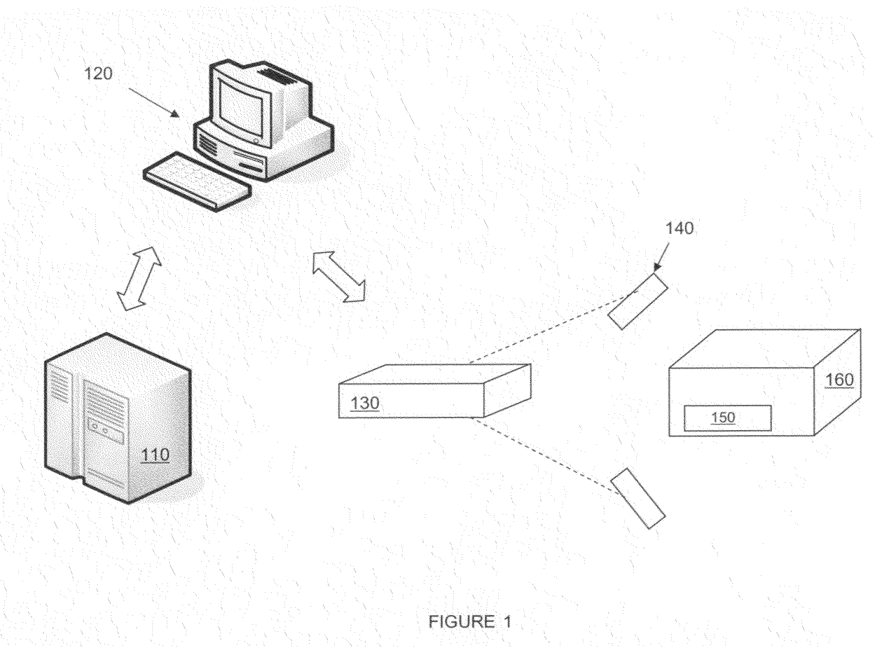

Referring initially to FIG. 1, illustrated is a system level diagram of an embodiment of an RFID system constructed according to the principles of the present invention. The RFID system includes a server 110, a computer system 120, and an RFID reader 130 with antennas (one of which is designated 140). The computer system 120 (in connection with the server 110) directs the RFID reader 130 to read RFID tag(s) 150 located on a product or host material 160. While a single product 160 is illustrated herein, those skilled in the art should understand that the product conceptually may also represent multiple products. In addition, the communication links between respective systems in the RFID system may be wired or wireless communication paths to facilitate the transmission of information therebetween. For a better understanding of communication theory, see the following references “Introduction to Spread Spectrum Communications,” by Roger L. Peterson, et al., Prentice Hall, Inc. (1995), “Modern Communications and Spread Spectrum,” by George R. Cooper, et al., McGraw-Hill Books, Inc. (1986), “An Introduction to Statistical Communication Theory,” by John B. Thomas, published by John Wiley & Sons, Ltd. (1995), “Wireless Communications, Principles and Practice,” by Theodore S. Rappaport, published by Prentice Hall, Inc. (1996), “The Comprehensive Guide to Wireless Technologies,” by Lawrence Harte, et al., published by APDG Publishing (1998), “Introduction to Wireless Local Loop,” by William Webb, published by Artech Home Publishers (1998), and “The Mobile Communications Handbook,” by Jerry D. Gibson, published by CRC Press in cooperation with IEEE Press (1996), all of which are incorporated herein by reference.

The RFID tag as described herein includes several features to accommodate the more severe applications and environments that lie ahead. The RFID tag includes additional layers of heat resistive material to laminate the RFID tag to create a mechanical strain retarder and a stronger substrate between an integrated circuit (also referred to as “IC” or chip) and an outer layer of laminate or encapsulant. The encapsulation of the RFID tag is typically a moldable, pliable material that protects the RFID tag from chemical exposure and lifts the RFID tag from a host material, thereby providing an offset so that the RFID tag can be read on metals and other RFID unfriendly materials. Obviously, many materials may be used to accommodate the aforementioned purposes.

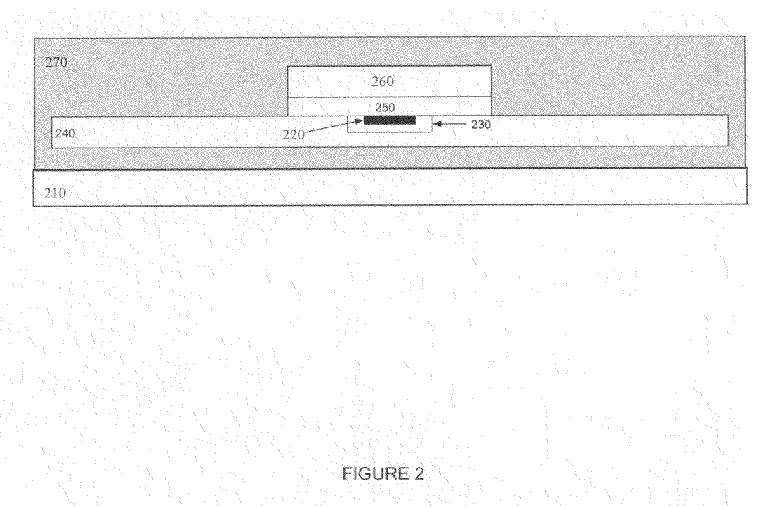

Turning now to FIG. 2, illustrated is a block diagram of an embodiment of an RFID tag constructed according to the principles of the present invention. The RFID tag is affixed or applied to a host material (e.g., a host material including a metal surface or a metal object) 210 and includes an integrated circuit 220 located or embodied in a carrier 230 coupled to an antenna 240. An adhesive 250 is coupled to (e.g., located above and proximate) the carrier 230 and a strain relief member 260 is located above and proximate (e.g., bonded) to the adhesive 250. More particularly, the strain relief member 260 is coupled to the adhesive 250 on a surface opposite the integrated circuit 220 and the carrier 230. In the illustrated embodiment, the adhesive 250 and the strain relief member 260 cover a surface area of the integrated circuit 220 and the carrier 230. The strain relief member 260 provides strain relief for the integrated circuit 220 when the RFID tag is subject to mechanical stress such as compressive or expansive forces. Additionally, the strain relief member 260 may be formed from a temperature resistive material (e.g., a heat resistive material). The RFID tag is encapsulated by an encapsulant 270, which is coupled to and provides an offset for the RFID tag in relation to the host material 210.

As mentioned above, the integrated circuit 220 is subject to damage from mechanical or thermal stress. In performing a failure analysis, under certain conditions, the integrated circuit 220 often experiences stress cracks that render the RFID tag inoperable. The strain relief member 260 located proximate the integrated circuit 220 provides higher rigidity as well as heat resistive characteristics. The strain relief member 260 provides rigidity through strain relief and inhibits movement about the integrated circuit 220 thereby reducing (e.g., preventing) potential stress fractures thereto.

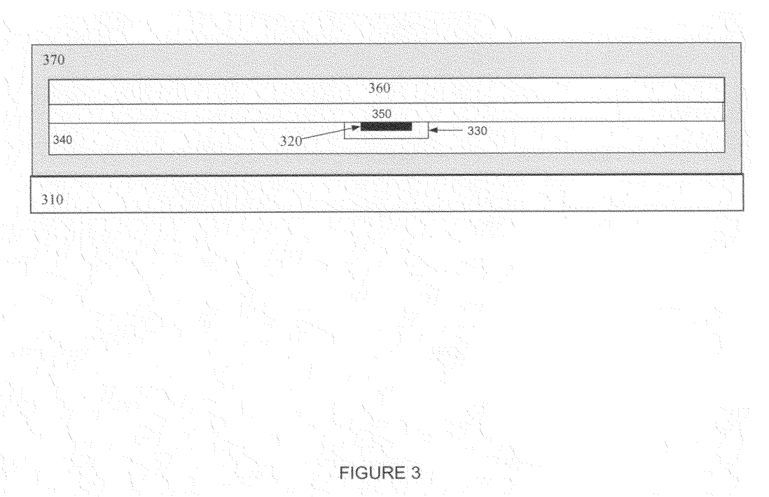

Turning now to FIG. 3, illustrated is a block diagram of an embodiment of an RFID tag constructed according to the principles of the present invention. The RFID tag is affixed or applied to a host material (e.g., a host material including a metal surface or a metal object) 310 and includes an integrated circuit 320 located or embodied in a carrier 330 coupled to an antenna 340. An adhesive 350 is coupled to (e.g., located above and proximate) the carrier 330 and the antenna 340. Additionally, a strain relief member 360 is located above and proximate (e.g., bonded) to the adhesive 350. More particularly, the strain relief member 360 is coupled to the adhesive 350 on a surface opposite the integrated circuit 320 and the carrier 330. In the illustrated embodiment, the adhesive 350 and the strain relief member 360 cover a surface area of the integrated circuit 320, the carrier 330 and the antenna 340. The strain relief member 360 provides strain relief for the integrated circuit 320 when the RFID tag is subject to mechanical stress such as compressive or expansive forces. Additionally, the strain relief member 360 may be formed from a temperature resistive material (e.g., a heat resistive material). The RFID tag is encapsulated by an encapsulant 370, which is coupled to and provides an offset for the RFID tag in relation to the host material 310.

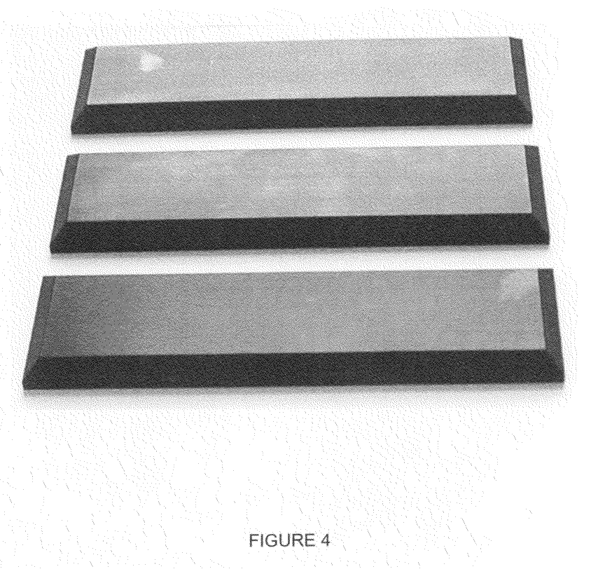

Turning now to FIG. 4, illustrated is a perspective view of an embodiment of an RFID tag constructed according to the principles of the present invention. The present embodiment illustrates fully encapsulated RFID tags employable in many environments as described herein. The encapsulant should be able to absorb high impacts in any environment and is preferably a material having a low dielectric constant through which the RFID tag can be read. The encapsulant should be approved for incidental food grade contact and sealed to prevent absorption of chemicals. The encapsulant should be adhereable to different materials using an adhesive or similar material.

When the RFID tag is applied directly to a metal surface detuning occurs due to the collapse of the magnetic field associated with the operation of the RFID tag. Providing an offset between the RFID tag and a metal surface will allow the RFID tag to be read consistently on metal and other RFID unfriendly materials. The proper offset thickness is based on design experience, and the thickness can vary to control the desired read range to achieve the greatest read range and rate on a metal surface. Those skilled in the art should readily understand that the RFID tag can take many shapes, sizes, etc. and be applied with any number of applications.

For a better understanding of RFID technologies, in general, see “RFID Handbook,” by Klaus Finkenzeller, published by John Wiley & Sons, Ltd., 2nd edition (2003), which is incorporated herein by reference. For a better understanding of RFID tags in compliance with the EPC, see “Technical Report 860 MHz-930 MHz Class I Radio Frequency Identification Tag Radio Frequency & Logical Communication Interface Specification Candidate Recommendation,” Version 1.0.1, November 2002, promulgated by the Auto-ID Center, Massachusetts Institute of Technology, 77 Massachusetts Avenue, Bldg 3-449, Cambridge Mass. 02139-4307, which is incorporated herein by reference. For a better understanding of conventional RFID readers, see the following RFID readers, namely, “MP9320 UHF Long-Range Reader” provided by SAMSys Technologies, Inc. of Ontario, Canada, “MR-1824 Sentinel-Prox Medium Range Reader” by Applied Wireless ID of Monsey, N.Y. (see also U.S. Pat. No. 5,594,384 entitled “Enhanced Peak Detector,” U.S. Pat. No. 6,377,176 entitled “Metal Compensated Radio Frequency Identification Reader,” U.S. Pat. No. 6,307,517 entitled “Metal Compensated Radio Frequency Identification Reader”), “2100 UAP Reader,” provided by Intermec Technologies Corporation of Everett, Wash. and “ALR-9780 Reader,” provided by Alien Technology Corporation of Morgan Hill, Calif., all of which are incorporated by reference.

Furthermore, for a better understanding of standards base work regarding RFID, see the EPCglobal standards and related publications, namely, EPCglobal release EPC Specification for Class 1 Gen 2 RFID Specification, December 2004, and a “Whitepaper: EPCglobal Class 1 Gen 2 RFID Specification,” published by Alien Technology Corporation, Morgan Hill, Calif. (2005). For a better understanding of RFID devices, see U.S. Pat. No. 6,853,087, entitled “Component and Antennae Assembly in Radio Frequency Identification Devices,” to Neuhaus, et al., issued Feb. 8, 2005. For related applications, see U.S. Patent Application Publication No. 2006/0212141, entitled “Radio Frequency Identification-Detect Ranking System and Method of Operating the Same,” Abraham, Jr., et al., published Sep. 21, 2006, and U.S. Patent Application Publication No. 2006/0212164, entitled “Radio Frequency Identification Application System,” to Abraham, Jr., et al., published Sep. 21, 2006. The aforementioned references, and all references herein, are incorporated herein by reference in their entirety.

Also, although the present invention and its advantages have been described in detail, it should be understood that various changes, substitutions and alterations can be made herein without departing from the spirit and scope of the invention as defined by the appended claims. For example, many of the materials and structures discussed above can be implemented in different materials and structures to advantageously form an RFID tag as described herein.

Moreover, the scope of the present application is not intended to be limited to the particular embodiments of the process, machine, manufacture, composition of matter, means, methods and steps described in the specification. As one of ordinary skilled in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A radio frequency identification (RFID) tag, comprising:
an integrated circuit located in a carrier;
an adhesive coupled to said carrier;
a strain relief member coupled to said adhesive on a surface opposite said carrier; and
an encapsulant surrounding said carrier, said adhesive and said strain relief member.

2. The RFID tag as recited in claim 1 wherein said adhesive and said strain relief member cover a surface area of said carrier.

3. The RFID tag as recited in claim 1 further comprising an antenna coupled to said carrier and surrounded by said encapsulant.

4. The RFID tag as recited in claim 1 further comprising an antenna coupled to said carrier and surrounded by said encapsulant, said adhesive and said strain relief member covering a surface area of said carrier and said antenna.

5. The RFID tag as recited in claim 1 wherein said RFID tag is affixed to a host material including a metal surface.

6. The RFID tag as recited in claim 1 wherein said strain relief member is configured to provide strain relief for said integrated circuit when said RFID tag is subject to mechanical stress.

7. The RFID tag as recited in claim 1 wherein said strain relief member is formed from a temperature resistive material.

8. A method of forming a radio frequency identification (RFID) tag, comprising:
providing an integrated circuit in a carrier;
coupling an adhesive to said carrier;
coupling a strain relief member to said adhesive on a surface opposite said carrier; and
surrounding said carrier, said adhesive and said strain relief member with an encapsulant.

9. The method as recited in claim 8 wherein said adhesive and said strain relief member cover a surface area of said carrier.

10. The method as recited in claim 8 further comprising coupling an antenna to said carrier and surrounding said antenna with said encapsulant.

11. The method as recited in claim 8 further comprising coupling an antenna to said carrier and surrounding said antenna with said encapsulant, said adhesive and said strain relief member covering a surface area of said carrier and said antenna.

12. The method as recited in claim 8 further comprising affixing said RFID tag to a host material including a metal surface.

13. The method as recited in claim 8 wherein said strain relief member is configured to provide strain relief for said integrated circuit when said RFID tag is subject to mechanical stress.

14. The method as recited in claim 8 wherein said strain relief member is formed from a temperature resistive material.

15. A radio frequency identification (RFID) system, comprising:
an RFID reader; and
an RFID tag, including:
an integrated circuit located in a carrier;
an adhesive coupled to said carrier;
a strain relief member coupled to said adhesive on a surface opposite said carrier; and
an encapsulant surrounding said carrier, said adhesive and said strain relief member.

16. The RFID system as recited in claim 15 wherein said adhesive and said strain relief member cover a surface area of said carrier.

17. The RFID system as recited in claim 15 wherein said RFID tag further includes an antenna coupled to said carrier and surrounded by said encapsulant.

18. The RFID system as recited in claim 15 wherein said RFID tag further includes an antenna coupled to said carrier and surrounded by said encapsulant, said adhesive and said strain relief member covering a surface area of said carrier and said antenna.

19. The RFID system as recited in claim 15 wherein said strain relief member is configured to provide strain relief for said integrated circuit when said RFID tag is subject to mechanical stress.

20. The RFID system as recited in claim 15 wherein said strain relief member is formed from a temperature resistive material.
